(19) United States
(12) Patent Application Publication
(10) Pub. No.: US 2015/0174547 A1
(43) Pub. Date: Jun. 25, 2015

(54) TRANSFECTION SYSTEMS, METHODS AND MEDIA

(71) Applicants: Neil Emans, Pretoria (ZA); Asongwe Lionel Ateh Tantoh, Cape Town (ZA)

(72) Inventors: Neil Emans, Pretoria (ZA); Asongwe Lionel Ateh Tantoh, Cape Town (ZA)

(21) Appl. No.: 14/137,459

(22) Filed: Dec. 20, 2013

(51) Int. Cl. B01J 19/00

(52) U.S. Cl. CPC B01J 19/0046; B01J 2219/0059; B01J 2219/00385

(57) ABSTRACT

Systems, methods and media for transfection are provided. In an example embodiment, a method of printing layered arrays of spots onto a substrate includes printing a first array of spots onto the substrate and allowing the first array of spots to dry. The method includes printing, over the first array of spots, a second array of spots, with the spots of the second array being at least partially coincident with the spots of the first array, and allowing the second array of spots to dry. The method may include printing, over the second array of spots, a third array of spots, the spots of the third array being at least partially coincident with the spots of the second array, and allowing the third array of spots to dry.

### TECHNICAL FIELD

The present disclosure relates generally to systems, methods and media for transfection. In one example, the disclosure provides a transfection system for the production of three dimensionally structured arrayed biochips and microarrays capable of modulating cellular responses.

### BACKGROUND

The sequencing of the human genome has identified more than twenty thousand human genes that then encode a larger number of proteins. Given the size of the genome and its complexity, there is a need for large scale experimental methods that can enable the complexity of cellular and disease biology to be quantified.

There is a need for these methods to be widely available, relatively easy to use and adapt, and capable of mass production. Conventional microarrays exhibit one approach to these issues, and typically comprise arrayed homogenous experiments deposited on a substrate. Microarrays are currently produced using methods such as lithography (affymetrix), contact printing (genomic solutions), or ink jet printing. Some conventional methods exploit robotic approaches that typically iteratively print a handful of spots and exchange solutions to produce entire homogenous arrays. This approach limits the speed for producing arrays of a plurality of samples, such as nucleotides that systematically vary and have unique sequences.

Some conventional technology includes the deposition of a homogenous mixture of chemistry in solution to enable so-called ‘reverse transfection’ of external agents into eukaryotic cells (for example, U.S. Pat. No. 6,544,790 issued on Apr. 8, 2003; and U.S. Pat. No. 6,951,757 issued on Oct. 4, 2005.) As one drawback, this technology does not include a means or method for systematically altering the composition of the mixture as part of, or within, a production process. As another drawback, there is no means or method for customizing the homogenous mixture ‘on the fly’ during production, or as part of the experimental process.

### SUMMARY

The present inventor has recognized, amongst other things, that problems to be solved can include those discussed above. The present subject matter can help provide a solution to these and other problems, such as by providing systems, methods and media for the production of arrayed experiments on substrates. In some examples, the arrayed experiments are built by forming a series of layers. The successive building of a series of individual layers enables a modular and highly adaptable experimental method for manipulating cells using external agents in the arrays. Arrays can include, for example, cDNA, oligo nucleotides, proteins, siRNAs, compound chips, and mammalian or microbial cells. Other arrays and external agents are possible.

In some examples, a system (including apparatus) for mass production of arrays is provided. The mass-production of arrays facilitates conducting a multitude of different experiments. The system may include printing elements of different sizes in some examples. Some example systems allow the production of series of coincident samples (spots) to be formed on the same physical location on a glass slide or substrate.

In some examples, the simultaneous mass production of an entire array is provided. The array may comprise a plurality of spots printed simultaneously on a substrate. This simultaneous printing can be achieved in some examples using a series of differently sized capillary tubes aligned with one another within a micro-engineered printing plate, wherein each capillary tube in the printing plate prints to the same physical location. Each printing plate may comprise a line of capillary tubes embedded within the plate. In some examples, the capillary tubes can articulate vertically within the plate when the capillary tubes contact the substrate. In some examples, the capillary tubes have varying diameters. In some examples, the layered arrays of spots can be printed using conventional techniques, such as contact printing, ink jet, bubble jet and low volume pipetting.

In order to form a printed spot having a three dimensional structure or organization, a method may include first printing one spot containing a sample and printing a coincident spot of the same or differing diameter over it and further printing additional spots coincident to the first. These operations can create a three dimensionally organized spot on a substrate. Further operations can permit the use of the layers as a series of modular, adjustable samples wherein each layer of the spot is capable of altering the overall spot properties. Although some examples described herein relate to transfection of cells using a foreign agent and the subsequent silencing of gene activity, the systems, methods and media described herein can find application in other domains.

In some examples, systems and methods are provided to mass produce arrays featuring so-called ‘layer cake’ (three-dimensional) spots, or ‘layerfection’ techniques. The present disclosure includes a description of how to stack multiple print plates into a print face, the print face comprising a plurality of capillaries ordered in an array. In some examples, some of the capillaries have different diameters with respect to others. The disclosed systems, methods and media can provide the ability to assemble and print arrays of three dimensionally ordered ‘layer cake’ spots as experiment sites from a movable type face in a series of single contacts with the substrate.

Thus, in one example embodiment, there is provided a printing apparatus for printing, onto a substrate, an array of spots of reagent composition, which apparatus includes: an array of capillary tubes arranged alongside one another and each having at least one open end, with the open ends of the tubes being aligned; displacement means for displacing the array of capillary tubes from an inoperative position to an operative position and back to the inoperative position; and substrate holding means for holding a substrate so that, in use, when the array of capillary tubes is displaced into its operative position, the open ends of the capillary tubes can simultaneously impinge against a substrate held by the substrate holding means with at least some reagent composition from the capillary tubes being deposited on the substrate as spots, thereby to form an array of spots of the reagent compositions on the substrate.

In another example embodiment, there is provided a method of printing, onto a substrate, layered arrays of spots, which method includes: printing a first array of spots onto the substrate; allowing the first array of spots to dry; printing, over the first array of spots, a second array of spots, the spots of the second array being at least partially coincident with the spots of the first array; allowing the second array of spots to dry; printing, over the second array of spots, a third array of spots, the spots of the third array being at least partially coincident with the spots of the second array; and allowing the third array of spots to dry.

In another example embodiment, a machine readable medium includes instructions that, when implemented, cause the machine to perform operations comprising: printing a first array of spots onto the substrate; receiving the first array of spots when dry; printing, over the first array of dried spots, a second array of spots, the spots of the second array being at least partially coincident with the spots of the first array; receiving the second array of spots when dry; printing, over the second array of dried spots, a third array of spots, the spots of the third array being at least partially coincident with the spots of the second array.

In another example embodiment, a system includes at least one module, executing on at least one computer processor, to: print a first array of spots onto the substrate; print, over the first array of dried spots, a second array of spots, the spots of the second array being at least partially coincident with the spots of the first array; and print, over the second array of dried spots, a third array of spots, the spots of the third array being at least partially coincident with the spots of the second array.

These and other examples and features of the present disclosure will be set forth in part in the following Detailed Description. This Summary is intended to provide non-limiting examples of the present subject matter—it is not intended to provide an exclusive or exhaustive explanation. The Detailed Description below is included to provide further information about the present disclosure.

### DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a schematic view illustrating the formation of a three-dimensional spot, in accordance with an example embodiment.

FIG. 2 depicts an example method of overlaying cells over a three-dimensional spot, in accordance with example embodiments.

FIG. 3 is a flow chart of an example method, in accordance with an example embodiment.

FIG. 4 depicts the formation of three-dimensional spots, in accordance with example embodiments.

FIG. 5 depicts images of sample spots, in accordance with example embodiments.

FIG. 6 depicts example layers of a three-dimensional spot, in accordance with example embodiments.

FIGS. 7-9 include views of imaged spots, in accordance with example embodiments. An enlarged view of the panel A shown in FIG. 9 is given in FIG. 9A. This view shows a printing head in a printing apparatus in accordance with an example embodiment.

FIGS. 10A-10F show flow charts depicting example operations of an example method, in accordance with example embodiments.

FIG. 11 is a block diagram of a machine in the example form of a computer system within which a set of instructions may be executed for causing the machine to perform any one or more of the methodologies herein discussed

### DETAILED DESCRIPTION

The following is a detailed description of illustrative embodiments of the present invention. As these embodiments of the present invention are described with reference to the aforementioned drawings, various modifications or adaptations of the methods and/or specific structures described may become apparent to those skilled in the art. All such modifications, adaptations, or variations that rely upon the teachings of the present inventive subject matter, and through which these teachings have advanced the art, are considered to be within the spirit and scope of the present disclosure. Hence, these descriptions and drawings are not to be considered in a limiting sense, as it is understood that the present inventive subject matter is in no way limited to the embodiments illustrated.

The present disclosure provides an approach for the production of arrayed experiments as spot sites on a substrate, as typified by a microarray or a gene silencing RNAi array. Disclosed herein are systems, methods and media for forming three dimensionally structured spots from a series of layers. A spot formed in this way produces a biochemical “layer cake” spot, or chip. Such layer cake spots can comprise a series of layers that can include solutions or chemicals that are capable of modifying the properties of the overall (ensemble) spot.

In one example of a three dimensional spot, one layer of the spot can include a nucleotide solution that is printed and dried onto a substrate (for example, glass, or treated glass) as a discrete spot. In some examples, this dried nucleotide cannot enable delivery into cells. The cell is resistant to such delivery. But a second layer of the spot printed coincidentally over the first layer of the spot may contain a transfection reagent solution (for example, effectene, lipofectamine 2000, or RNAimax). The second layer of the spot can add function to the ensemble spot, by enabling or at least accelerating transfection of the printed nucleotide into the cells. A further third layer printed over the second layer may include a solution of a polymer, for example, gelatin, fibronectin, collagen, hydrogel, or poly lactic-co-glycolic acid (PLGA). An appropriate polymer layer can add functionality to the ensemble spot by entrapping the two previous layers, or preventing escape of the two layers. The applied layers are not washed off and remain to increase the efficiency of the transfection of nucleotide into cells. In such a manner, cells can be grown to overlay the ensemble spots and receive spot localized transfection that is greater than the sum of its parts. Some examples include self-transfecting siRNA, such as accell from dharmacon for example which can diffuse out of a spot layer into a cell.

Further, this example method can generate production benefits. As suggested above, a plurality of chemical samples (such as siRNA, encapsulated siRNA, oligonucleotides, proteins, cells, or compounds) can be printed as one layer of spots. These can then be stored, for example, as subset A and then subsequently coincidentally printed with a second transfection layer. The first and second layers can be dried and stored, for example, as subset B. Subset A or B can then coincidentally be printed with a different transfection layer, forming subset C, and so forth. The layering principle can be extended to further layers and/or across time in phased time periods or timed storage protocols.

In some examples, a layer can be stored almost indefinitely which allows new transfection reagents, perhaps appearing or becoming available much later than the first layer was printed, to be used as second, third or fourth layers, and so forth. Similarly, should subsequent evidence or data come to light indicating that existing or new transfection agents are potentially superior or of improved utility than those currently available, these agents can be used even though they were not available when layers of the spot were printed earlier. The layer cake method can thus provide a modular production process capable of adaptation to suit many different types of desired experiments and experimental arrays.

Printing layers on a substrate provides further manufacturing benefits. In some examples, solutions can be printed onto the substrate when an appropriate method meets and suits the solution being deposited. For example, a library of one hundred sequence-differentiated nucleotides can be printed to a substrate as individual spots using contact printing (spot by spot or by employing other methods described herein) which can accommodate plurality printing. Another layer of spots can be printed using a single solution (for example transfection reagent or a polymer) using a method that is less well suited to handling plurality printing but better suited to mass production printing, for example ink jet or bubble jet printing. In some examples, use of a cell adhesion factor, such as poly-1-lysine, in a nucleotide library or as a subsequent layer can provide a desired plurality of spots and associated arrays.

The present disclosure can provide great flexibility in building a three dimensional sample spot and thus can minimize conventional problems of inflexibility that arise in printing a plurality of homogenous sample spots constrained to be of the same type or content.

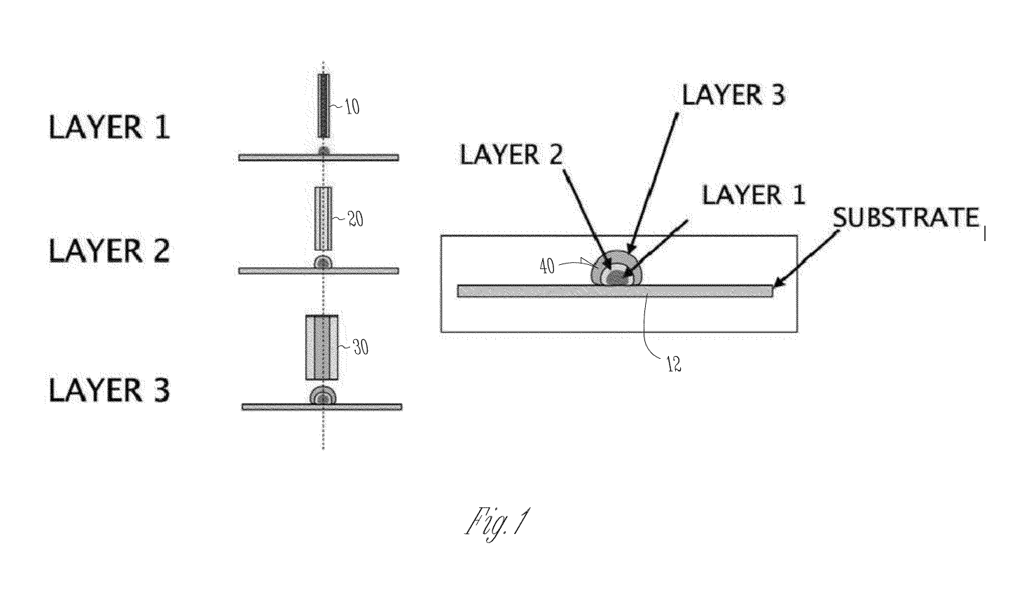

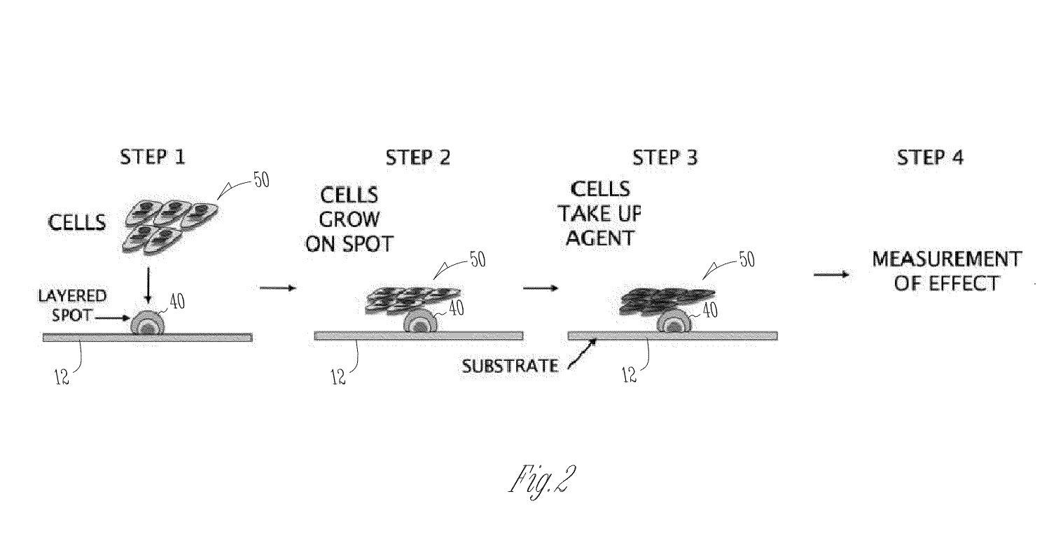

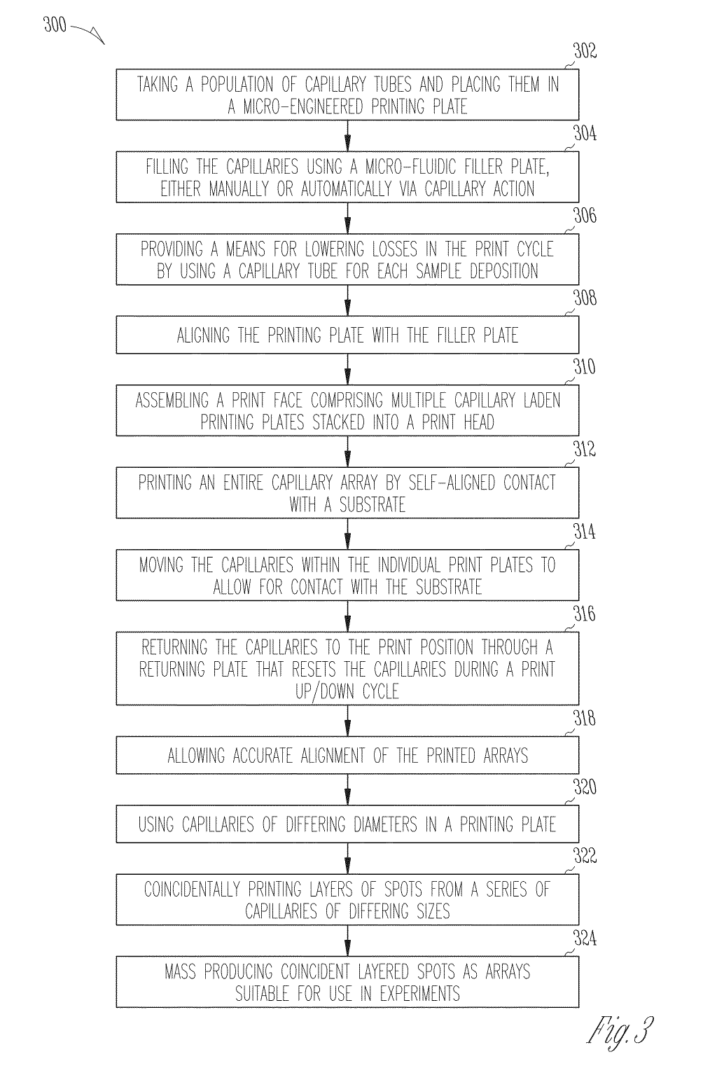

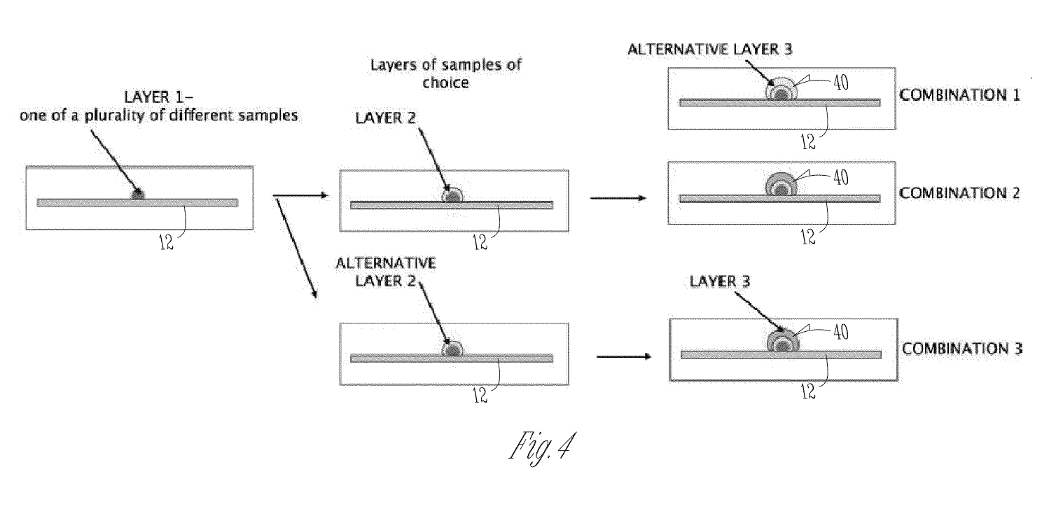

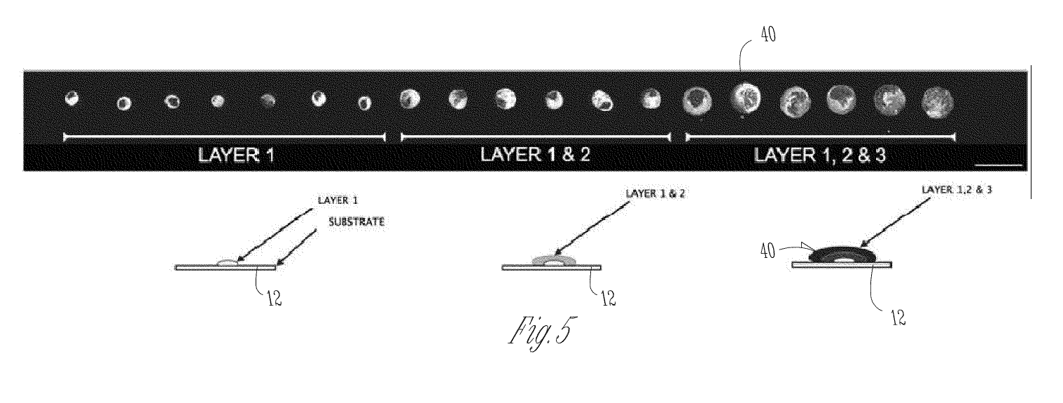

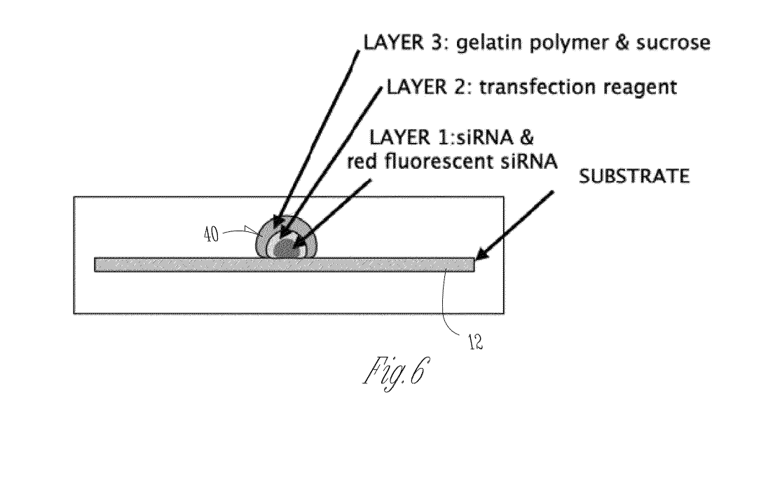

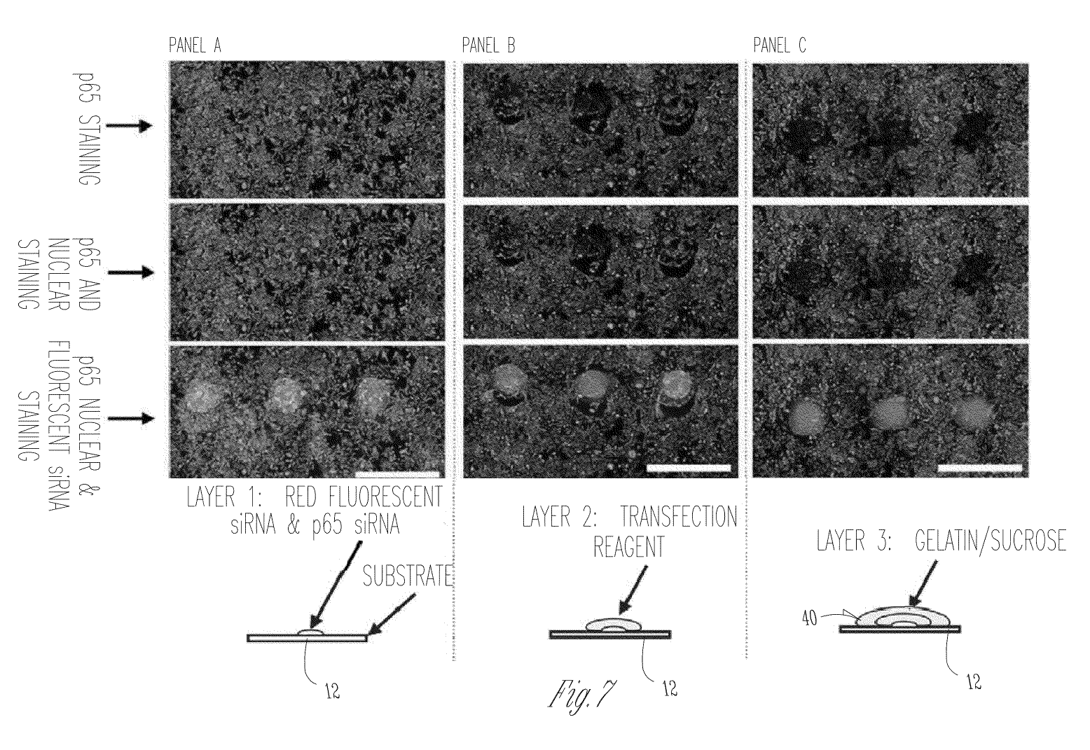

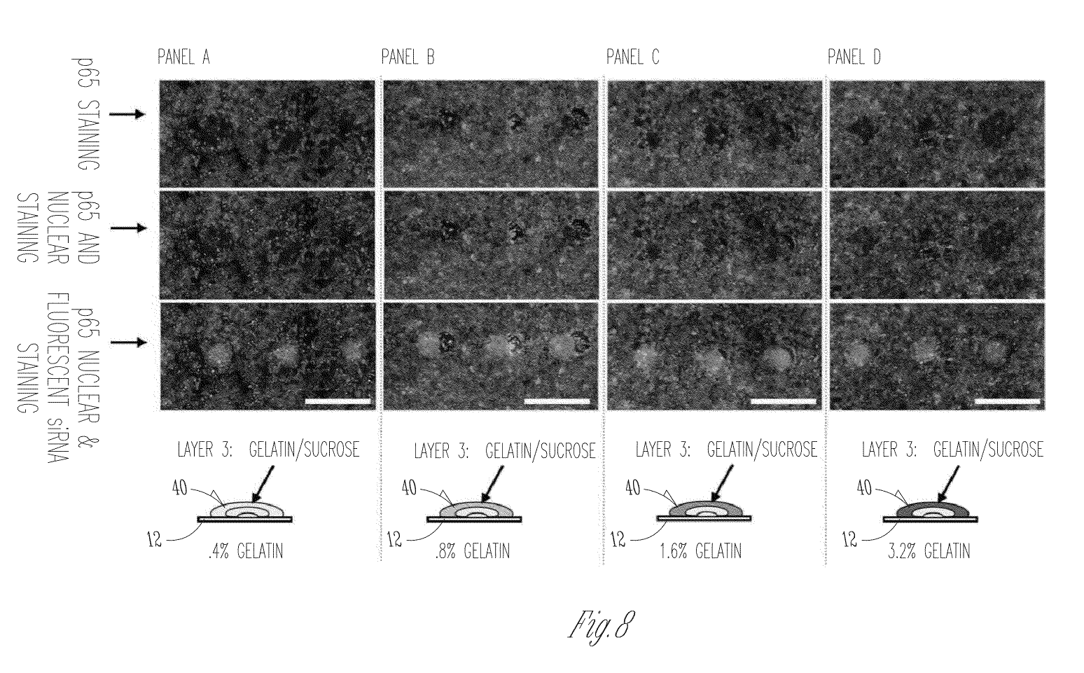

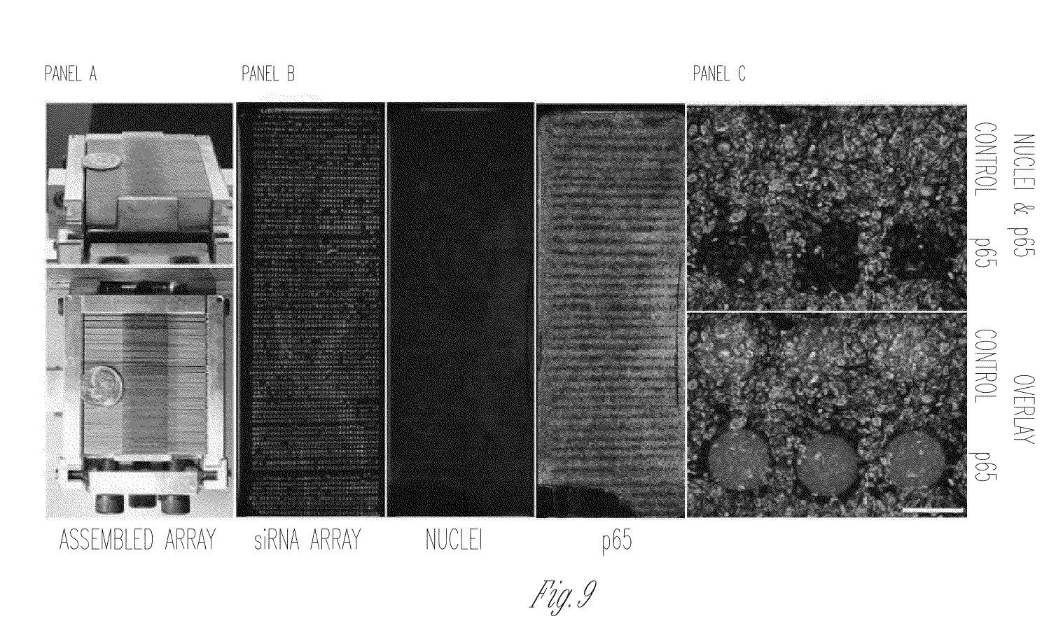

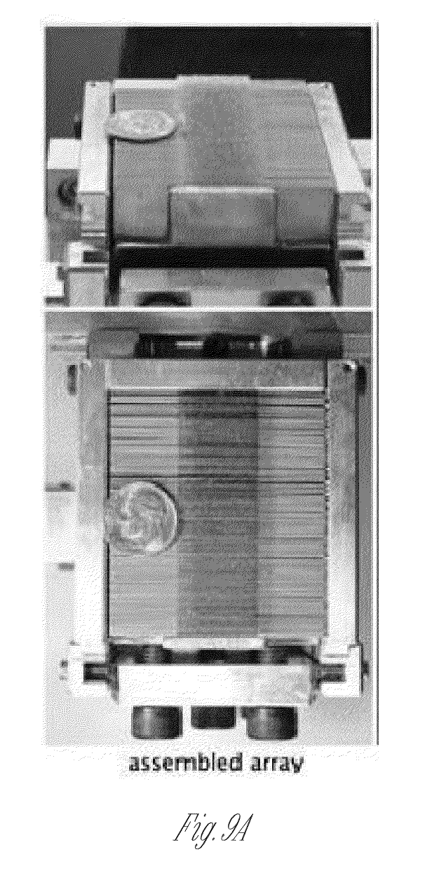

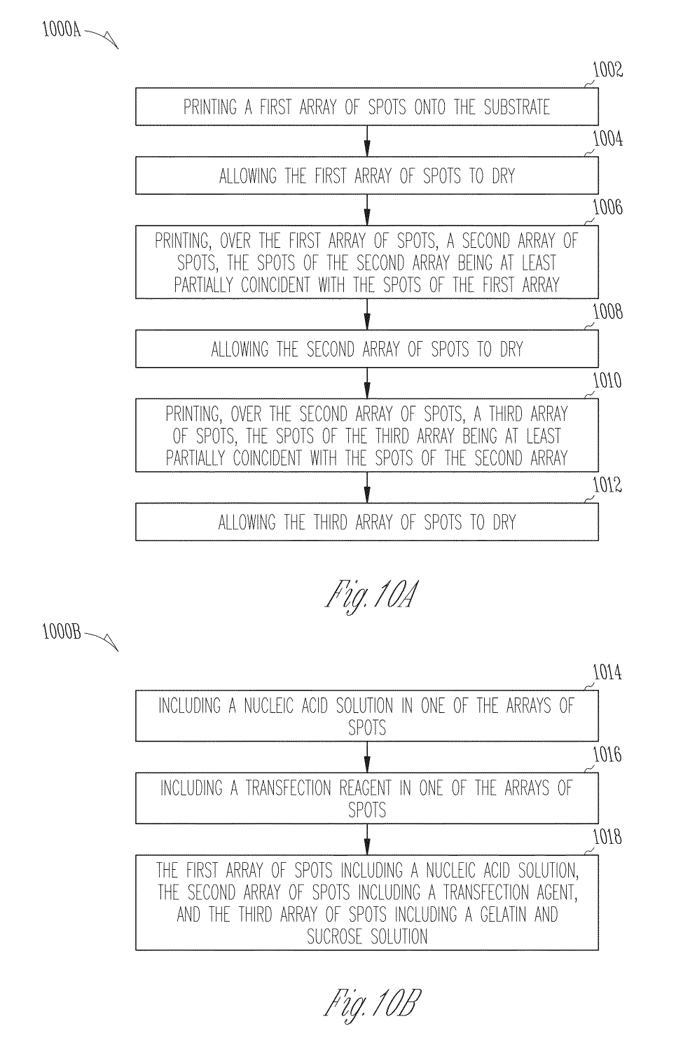

Reference is now made to FIG. 1 of the accompanying drawings, in which a capillary 10 of desired diameter is utilized to contact print a spot 40 on a substrate 12 to form a first layer, Layer 1. A second capillary 20, which may or may not be of larger diameter than the first capillary 10, prints a spot coincident with and over the first spot to form a second layer, Layer 2. A third capillary 30 which may or may not be larger in diameter than the other capillaries then deposits a third coincident sample on top of the previous layers to form a third layer of the ensemble spot, Layer 3. In an example embodiment, Layer 1 includes a small interfering siRNA, Layer 2 includes a transfection agent capable of catalyzing siRNA entry into cells and Layer 3 includes a polymer such as gelatin used to cap the spot and restrict its movement. A three-dimensional, layered spot 40 is thus formed.

With reference to FIG. 2 of the accompanying drawings, an example method of transfection can include example steps 1 through 4. Step 1 includes overlaying a spot 40 (for example as described above) on a substrate 12 with cells 50, such as mammalian or human cells. In step 2, the cells 50 are allowed to grow on the spot 40. In step 3, the cells 50 take up the siRNA in a localized manner through the combined action of the three layers. In step 4, the effects of the siRNA take-up can be measured. Each of the steps 1 through 4 may occur in timed intervals. A fluorescent dye may be present in the spots to enable visualization, this may be a fluorescent nucleotide or siRNA in one embodiment.

Some embodiments of example systems include a ‘movable type’ printer apparatus capable of mass producing multitudes of arrays of layered spots. The disclosed systems and methods can thus be applied with convenience in many aspects of substrate-related biologically integrated devices (for example, ‘biochips, ‘microarrays’, ‘protein chips’, and so forth). In some examples, individual capillaries of various diameters or sizes in a printing head can each carry unique experimental chemical solutions, and can be loaded as lines of printable chemistry in a series of printing plates with the plates stacking together to create a capillary array typeface. Each array can present a set of capillaries of differing sizes or a unitary capillary print face of one size that differs as desirable from the other capillaries within the production of arrays. In contrast to conventional techniques, the current subject matter permits the production of a first layer of spots comprising a plurality of samples printed simultaneously as an array of spots of defined size.

By separating the chemistries that otherwise limit the overall activity or attributes of a homogenously formed spot, the present subject matter can allow the first layer of spots in an array of spots to be stored while a second layer of spots is printed on another set of spots in an array on a different substrate. This adaption can be applied to many different arrays and many different substrates. The approach allows modularity in the array production process, and a comprehensive or scarce library of compounds can be mass produced and stored as needed for a variety of subsequent experiments or techniques. Further customized layers can be introduced over the initial spots which may vary their initial content and activity.

With reference to FIG. 3 of the accompanying drawings, an example method 300 is provided for producing arrayed experimental features on a substrate. The method 300 may comprise example operations including: at operation 302, providing a population of capillary tubes and placing them in a micro-engineered printing plate; at operation 304, filling the capillaries using a micro-fluidic filler plate, either manually or automatically via capillary action; at operation 306, providing a means for lowering losses in the print cycle by using a capillary tube for each sample deposition; at operation 308, aligning the printing plate with the filler plate; at operation 310, assembling a print face comprising multiple capillary laden printing plates stacked into a print head; at operation 312, printing an entire capillary array by self-aligned contact with a substrate; at operation 314, moving the capillaries within the individual print plates to allow for contact with the substrate; at operation 316, returning the capillaries to the print position through a returning plate that resets the capillaries during a print up/down cycle; at operation 318, allowing accurate alignment of the printed arrays; at operation 320, using capillaries of differing diameters in a printing plate; at operation 322, coincidentally printing layers of samples (spots) from a series of capillaries of differing sizes; and, at operation 324, mass producing coincident layered spots as arrays suitable for use in experiments. This disclosure can thus provide, in some examples, the means and methods for a novel layered transfection method that is modular and the means for scaling this to large scale production.

In some examples, the present disclosure includes the production of a ‘layer cake’ experiment enabling transfection of small interfering RNA oligonucleotides for use in gene silencing based functional genomics.

With reference to FIG. 4 of the accompanying drawings, a three dimensionally organized spot 40 can be produced in a series of layers of different spot samples printed using capillaries of different diameter that can print coincidently on the same location on a substrate 12. This method can produce a spot 40 in which the various component layers endow the spot with the spot's overall characteristics and activity. These characteristics and activities can be varied individually or in combination. Spot geometry, storage time and physical characteristics, for example, are some aspects that can be adjusted either individually or in combination to vary the overall characteristics of the spot, or any one of the layers within it.

For example, the layer labeled as Layer 1 in FIG. 4 can be one of a plurality of different samples. Layer 2 in FIG. 4 can include alternate layers of samples, for example to derive a first type of Layer 2, or an alternate type of Layer 2. It will be appreciated that the disclosed subject matter allows great flexibility and convenience in applying spot layers and that the present disclosure allows a wide range of experiments to be carried out. The range of experiments can be further amplified in exponent manner in varying the attributes of Layer 3 (or further layers). The views in FIG. 4 depict three possible combinations of three-dimensionally organized spots 40. Many other combinations are possible.

In further aspects of this disclosure, apparatus for producing very high density arrays is provided. In some examples, high density arrays can include many thousands of experiments (for example, over 2700 experiments) in one substrate contact made in seconds, with each spot 40 having a chosen three-dimensional geometry as described just above. Each layer of a high density array can be mass produced at a scale of 1000 identical prints in 3-4 hours. In approximately 70 hours, 3000-5000 printed examples can be produced. In some examples, other spot samples or layers can be additively overlaid spot by spot with the devices described here, or in another manner.

Thus, in one aspect, the present disclosure can be considered as a method for the transfection of cells which encourages the variable delivery of a nucleotide into mammalian cells, for example, that are normally resistant to such delivery. The three-dimensional (or ‘layer cake’) spots described herein can facilitate such methods, including reverse transfection in which solid state arrays of encapsulated cDNAs or siRNAs are printed onto a glass substrate. In the present disclosure, spots can be deposited on a substrate using a manual or robotic printing element that iteratively prints a plurality of samples, one at a time. In some examples, this technology has been applied to printing high density arrays where up to 3150 individual nucleotides were printed and used for genome scaled screening.

In still further aspects, the present subject matter provides apparatus capable of printing a layered three dimensional spot (for example, as described above), then an entire array of layered spots in a series of single, parallel coincident contact events with the substrate. This can be achieved using a print array including individual capillary print elements each containing, for example, a single siRNA solution and each having, for example, a defined size. In order to make head loading of the capillary print elements practical, each line of the array comprises 35 capillaries loaded in a micro-engineered printing plate. When the capillaries are filled and the plates stacked together, a “movable type” siRNA printing face is created. Print plates can be loaded with siRNA solution using a microfluidic filler plate which can enable easy, manual, parallel filling of the tubes through capillary action. Up to one hundred print plates can be stacked into a print head to generate an array of, for example, 2600 tubes, each bearing a unique siRNA sample. Contact with a glass array slide can enable the print face to deposit one entire array in one contact without the need for iterative robotic steps. Further, thousands of identical arrays can be printed from one print array. This enables the arrays to be mass produced, equivalent to printing one page of text over and over. The printed arrays can then be used in RNA interference in screening, for example. Further, in some examples, a means for producing arrays with larger capillaries is provided. These means can form a print head that can print a second or third layer of spots coincident with the first.

One example of the present subject matter includes mechanical production of a layer cake of spot samples 40 via sequential coincident printing. With reference to FIG. 5 of the accompanying drawings, a first array of 330 μm outer diameter, 220 μm inner diameter, borosilicate glass capillary tubes were used to print a line of siRNA spots, depicted as Layer 1 in FIG. 5. In order to demonstrate feasibility of the methods described herein, each capillary tube was filled with a solution containing a red fluorescent dye and brought into contact with a glass substrate. The dye in each spot sample was then imaged using a fluorescent microscope. The dye is not shown in color in FIG. 5, but a color view can be provided on request under the appropriate USPTO regulations.

The spot samples were then dried and a second round of spots was then printed over Layer 1 to form a Layer 2 in FIG. 5. The second overlaid spots also contained a red fluorescent dye. A third layer of spots, Layer 3 in FIG. 5, also containing a red fluorescent dye in each spot, was successfully printed coincidently over Layer 1 and Layer 2, to form a three-dimensional spot 40. This experiment demonstrated the mechanical feasibility of using a series of printing plates each bearing different size capillaries arranged to print three-dimensionally organized spots 40, each spot 40 having layers at the same position on a substrate 12 to which the individual spot layers were applied. FIG. 6 of the accompanying drawings shows a spot 40 having three sizes of example spot layers (Layers 1, 2, and 3) at coincident locations on a substrate 12.

With reference to FIG. 7 of the accompanying drawings, a further example of the present subject matter is now described. The example includes gene silencing via layer cake based transfection. In order to assess the use of the disclosed method for the silencing of gene expression using siRNA, a layer of siRNA from stock solution was first printed (Layer 1) using 330 μm outer diameter capillaries. The siRNA solution comprised both red fluorescent siRNA as a non-targeting control and an siRNA directed toward the NFkB subunit p65. The samples printed on the glass substrate were dried for 48-72 h. The red dye siRNA was added to make the spots visible for imaging based detection. Other imaging elements are possible and can vary in terms of the coupled fluorophore or be replaced with a suitable alternative that is not an siRNA (protein, polymer bearing dye).

A second layer (Layer 2) of transfection reagent (such as RNAi max invitrogen) was printed coincidently over the array of first spots in Layer 1 using 400 μm outer diameter capillaries and the samples were dried for 72-96 hours. A third layer of spots (Layer 3) of a polymer (such as gelatin and sucrose solution) was printed coincidently over the first and second spots and the entire assemblies of spots were dried for 3-5 days. As shown in FIG. 7, sample spots were thus built by printing initially a Layer 1 alone (including an siRNA), then a Layer 2 (the spot thus including altogether an siRNA and a transfection reagent), then a Layer 3 (the spot thus ultimately including an siRNA, a transfection reagent, and a polymer).

The three-layered printed spots were then overlaid with live human cells and placed into culture for 48 hours. Controls comprising the first two layers were also included. After 48 hours, cells were chemically fixed and stained with antibodies directed toward p65 and imaged. Color photographs of the imaged samples are shown in FIG. 7, displaying respectively in panels A through C for successively layered spots: p65 staining; p65 and nuclear staining; and, p65, nuclear, and fluorescent siRNA staining (red spots visible).

The layer cake method used in the second example gave comparable gene silencing to a homogenous (conventional) mixture when a sample spot contained the three layers (FIG. 7, panel C). The dual-layered spots including Layers 1 and 2 (i.e., the siRNA solution described above in Layer 1, plus a transfection reagent in Layer 2) yielded substantively less transfection and gene silencing. The silencing was also not localized (see FIG. 7, panel B). Finally, no local gene silencing was exhibited when p65 siRNA alone was printed as a single layer in Layer 1 (FIG. 7, panel A).

It was further noted that p65 expression was quantified over an ensemble spot built of Layers 1, 2, and 3 following automated spot detection and cell recognition operations. The expression of p65 was silenced over p65 spots by approximately 75% compared to cells on control areas of the array (p<0.0001). Cell morphology was unaltered on the spotted control layer of siRNA compared to unspotted regions of the array. The samples included 80-210 cells per spot. This density ratio can be varied depending on the size of cells being used in the experiment.

In order to demonstrate the further utility of the three-dimensional geometry of the ‘layer cake’ sample spots, a third experiment was performed in which the topology (order) of the layers was inverted. In this case, the layers including siRNA as described above were printed on a layer of (in order) a gelatin and transfection reagent and, in an alternate case, a layer of a transfection reagent and gelatin. In both cases, there was little or no gene silencing and the spots could only be physically localized for the siRNA elements which had dissolved into the cell culture medium.

With reference to FIG. 8 of the accompanying drawings, a further experiment was conducted to seek to demonstrate an ease of optimizing or varying the different types of experiments that can be conducted using the methods described in this disclosure. Here, the effect of using different upper gelatin layers was tested in terms of gelatin concentration. A plurality of slides (substrates) was printed with the siRNA elements described above followed by a larger capping spot layer of gelatin in a range of concentrations geometrically increasing from 0.4% w/v to 3.2% w/v. In the illustrated examples, the percent w/v of gelatin was increased incrementally from 0.4%, to 0.8%, to 1.6%, to 3.2% respectively for panels A through D. Thus, the sole variable was the gelatin capping layer, for all other reagents remained identical within a predefined structure of spot. As shown in FIG. 8, gene silencing was more localized with increasing gelatin concentration, taking into account batch to batch variation in transfection reagent and gelatin quality.

With reference to FIG. 9 of the accompanying drawings, a further experiment was conducted to include a high density printing array capable of printing an entire array of spots in one contact. In this example, the aim was to develop a method to assemble each line of the array stepwise and then bring these together to form a print face capable of printing an entire array in one contact. In this case, an array using one size of capillaries embedded in 500 μm plates at 500 μm pitch with 35/plate is shown. Following the movable type printing press paradigm, a set of micro-engineered printing plates were created to hold an entire array for testing. Each printing plate comprised a 800 μm stainless steel slab carrying 19 etched channels, each channel capable of holding a vertical capillary. When filled, 35 capillaries were supported in the plate at a 500 μm center-to-center pitch. Three such plates were produced to allow an optimal seating of capillaries having the following outer diameters: a) 250 μm, b) 330 & 400 μm, and c) 550 μm.

An entire array print face was assembled from a stack of sequential printing plates each stacked full with capillary tubes having one of the outer diameters specified above and bearing encapsulated siRNA solutions of the type described above. Given that the printing plates vary only in their capacity to bear capillaries, various arrays can be assembled having a plurality of sizes arranged in lines or in a set including capillaries of the same outer diameter.

Each capillary in a plate was individually filled with an encapsulated siRNA using either a micro-fluidic filler plate for 330 μm outer diameter capillaries or a filling trough for the larger sizes, as needed, and then placed into a print head to assemble an entire print face. When the print head was fully loaded, the printing plates were aligned using pressure to pack the plates. An adjustable side plate was used to line all the capillaries into a rectangular array comprising several thousand loaded printing tubes. This arrangement is visible in the enlarged view of panel A given in FIG. 9A of the accompanying drawings. The print head arrangement enables an entire printing array to be assembled from “moveable type”, as it were, and printed in one contact. It was noted that the proposed assembly of plates permitted sufficient mechanical alignment for coincident printing of several layers of spots at substantially the same positions within an array. Panel B of FIG. 9 shows views of an (siRNA) layer, a second (nuclei) layer, and a third (p65) layer under imaging microscope.

In further aspects of this experiment, the assembled print head was mounted on a single axis robotic printer. Manual loading of the printing plates was conducted in a custom HEPA filtered clean hood before their assembly into the printing head. When fully loaded, this assembly created a printing head carrying a maximum of 75-80 printing plates each carrying 35-36 sample arrays of spots each comprising in 2625 (or more) individual sample spots. Printing efficiency was in some aspects dependent on printing contact time (with the substrate), relative humidity and substrate coating. A 2.5 second contact printed the entire array on the substrate, with the capillaries moving independently and vertically within the printing plates to allow contact over a range of distances and substrate thicknesses on the printer down cycle. In order to print arrays repetitively, the displaced capillaries were pushed back down to the print position by a returning plate passing through the print head after the first contact print. Example apparatus for use in at least some of the experiments and methods described herein is described and illustrated in PCT published application WO 2013/014619 A2 (Emans), the contents of which are incorporated herein in their entirety.

### Method Embodiments

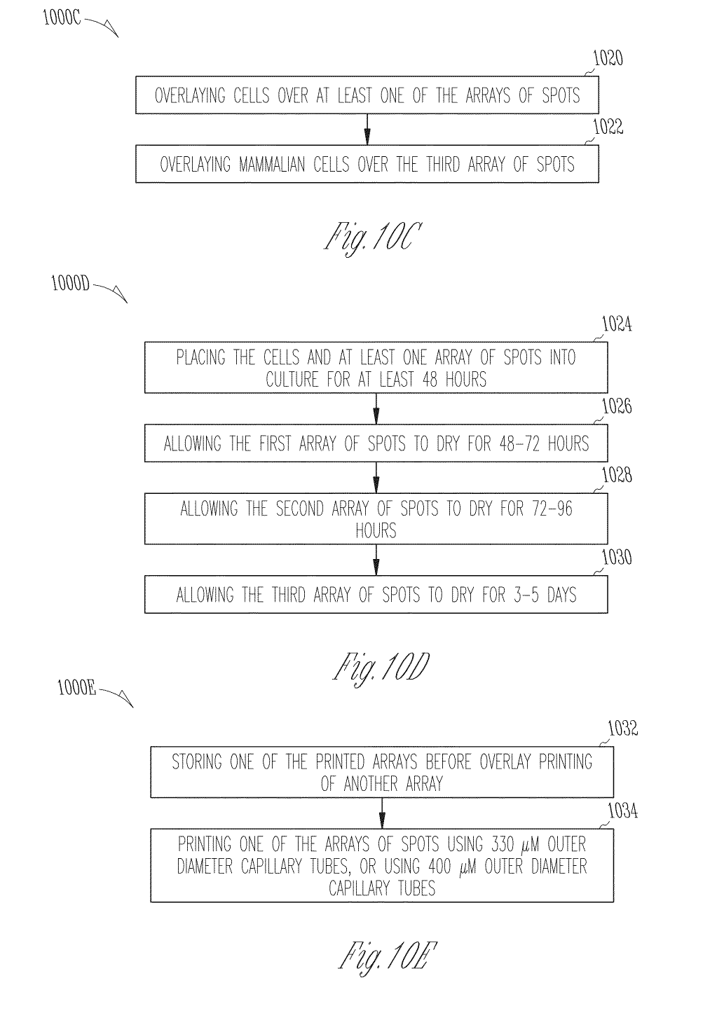

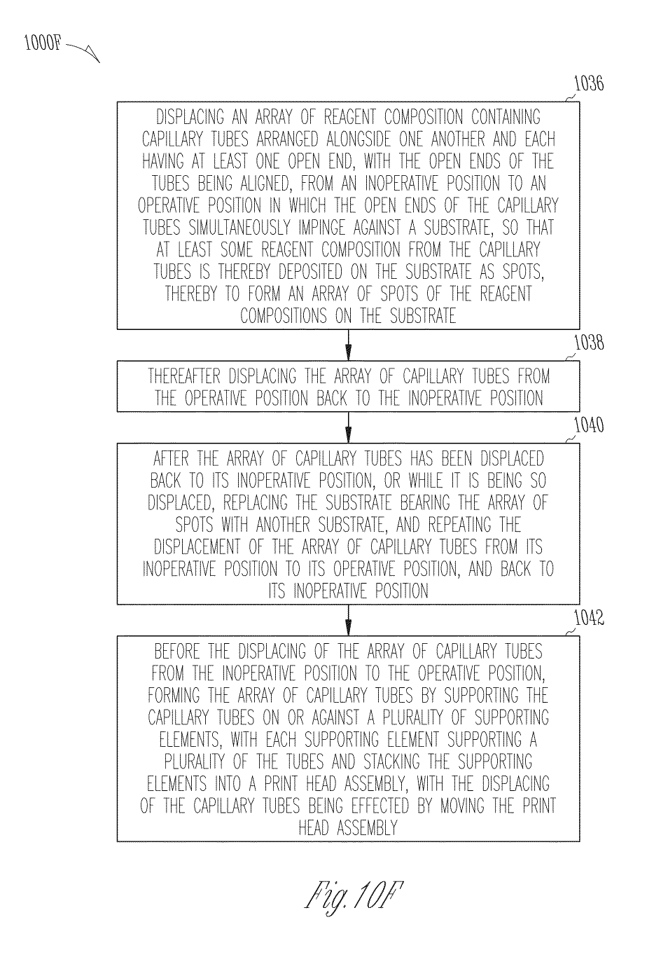

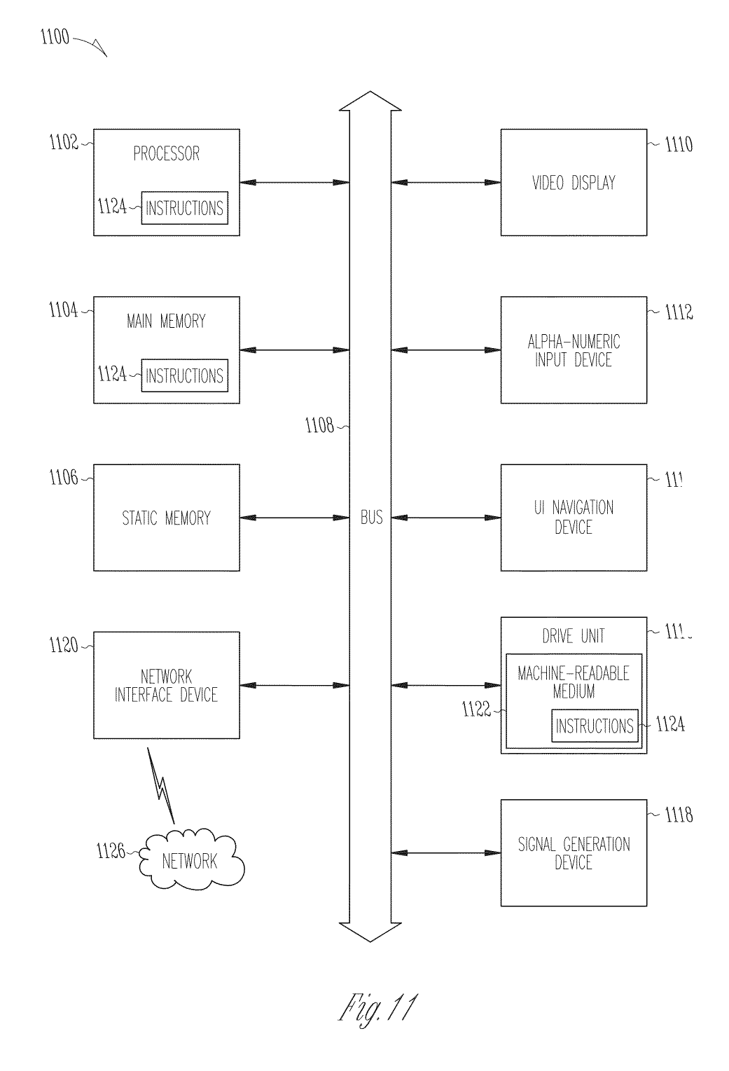

Some embodiments of the present inventive subject matter include methods of printing, onto a substrate, layered arrays of spots. One such method embodiment 1000 is illustrated in FIGS. 10A-10F of the accompanying drawings. The method 1000 may include portions 1000A-1000F illustrated in respective flow charts in FIGS. 10A-10F.

In the example embodiment shown in FIG. 10A, a method 1000 of printing, onto a substrate, layered arrays of spots, includes: at operation 1002, printing a first array of spots onto the substrate; at operation 1004, allowing the first array of spots to dry; at operation 1006, printing, over the first array of spots, a second array of spots, the spots of the second array being at least partially coincident with the spots of the first array; at operation 1008, allowing the second array of spots to dry; at operation 1010, printing, over the second array of spots, a third array of spots, the spots of the third array being at least partially coincident with the spots of the second array; and, at operation 1012, allowing the third array of spots to dry.

In some examples, one or more layers of a three-dimensional spot may include or be formed by a single, continuous layer covering an entire array of spots, or area of a substrate. In other words, each layer in a three-dimensional spot may not necessarily be constituted by a discrete spot. In one example, a first layer of discrete spots may be printed on a substrate. A continuous layer (as opposed to discrete spots) may then be applied (for example, by ‘painting’, or by ‘inkjet’ technique) over the first layer of discrete spots. A third layer might then be applied over the second layer as discrete spots, or as a further continuous layer. It will be appreciated that many combinations and configurations of spots and layers (discrete or continuous) are possible.

With reference to FIG. 10B, the method 1000 may further comprise, at operation 1014, including a nucleic acid solution in one of the arrays of spots. The method 1000 may further comprise, at operation 1016, including a transfection reagent in one of the arrays of spots. Still further, the method 1000 may further comprise including a gelatin solution in one of the arrays of spots. In some examples, at operation 1018, the first array of spots includes a nucleic acid solution, the second array of spots includes a transfection agent, and the third array of spots includes a gelatin and sucrose solution.

With reference to FIG. 10C, the method 1000 may further comprise, at operation 1020, overlaying cells over at least one of the arrays of spots. At operation 1022, the method 1000 may further comprise overlaying mammalian cells over the third array of spots.

With reference to FIG. 10D, the method 1000 may further comprise, at operation 1024, placing the cells and at least one array of spots into culture for at least 48 hours. In some examples, the method 1000 further comprises chemically fixing and staining the cells with antibodies, and imaging the cells. In some examples, 150 to 210 cells are overlaid per spot. The method 1000 may further comprise, at operation 1026, allowing the first array of spots to dry for 48-72 hours. In some examples, the method 1000 further comprises, at operation 1028, allowing the second array of spots to dry for 72-96 hours. In some examples, the method 1000 further includes, at operation 1030, allowing the third array of spots to dry for 3-5 days. The method 1000 may further comprise including a fluorescent dye in one of the arrays of spots, and imaging the spots using a fluorescent imaging device.

In some examples, the nucleic acid solution includes an RNA and/or a DNA encoded expression vector. The RNA in the nucleic acid solution may include an siRNA, a μRNA, or a non-coding RNA. In some examples, the expression vector in the nucleic acid solution includes a cDNA expression, an shRNA expression, a DNA cvector, or similarly functional genomic DNA encoded vector.

The nucleic acid solution may include a fluorescent dye labeled nucleotide and a control such as siRNA directed toward the NFkB subunit p65. The transfection reagent may include RNAi max invitrogen.

With reference to FIG. 10E, the method 1000 may further comprise, at operation 1032, storing one of the printed arrays before overlay printing of another array. Operation 1034 may include printing one of the arrays of spots using 330 μm outer diameter capillary tubes, or using 400 μm outer diameter capillary tubes. In some examples, at least one printed array of spots includes spots of a different size to spots included in another array of printed spots. In some examples, the concentration of gelatin in the gelatin solution is in the range 0.4% to 3.2% w/v. In some examples, the first, second and third arrays of spots substantially coincide and form layered transfection arrays on the substrate when dry.

In some examples, and with reference to FIG. 10F, the layered arrays of spots of reagent compositions formed in method 1000 may each printed by, at operation 1036, displacing an array of reagent composition containing capillary tubes arranged alongside one another and each having at least one open end, with the open ends of the tubes being aligned, from an inoperative position to an operative position in which the open ends of the capillary tubes simultaneously impinge against a substrate, so that at least some reagent composition from the capillary tubes is thereby deposited on the substrate as spots, thereby to form an array of spots of the reagent compositions on the substrate; and, at operation 1038, thereafter displacing the array of capillary tubes from the operative position back to the inoperative position.

The method 1000 may further comprise, at operation 1040, after the array of capillary tubes has been displaced back to its inoperative position, or while it is being so displaced, replacing the substrate bearing the array of spots with another substrate, and repeating the displacement of the array of capillary tubes from its inoperative position to its operative position, and back to its inoperative position.

In some examples, the method 1000 may further include, at operation 1042, before the displacing of the array of capillary tubes from the inoperative position to the operative position, forming the array of capillary tubes by supporting the capillary tubes on or against a plurality of supporting elements, with each supporting element supporting a plurality of the tubes and stacking the supporting elements into a print head assembly, with the displacing of the capillary tubes being effected by moving the print head assembly.

These method embodiments are also referred to herein as “examples.” Such examples can include method elements in addition to those shown or described. However, the present inventor also contemplates examples in which only some of the method elements shown or described are provided. Moreover, the present inventor also contemplates examples using any combination or permutation of those method elements shown or described above (or one or more aspects thereof), either with respect to a particular example (or one or more aspects thereof), or with respect to other examples (or one or more aspects thereof) shown or described herein.

### Processor Implementation

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Eletronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures usually merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation or cursor control device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more data structures or instructions 1124. The term “machine-readable medium” shall also be taken to include any tangible medium that is capable of storing, encoding, or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-Fi™ and WiMax™ networks). The term “transmission medium” shall be taken to include any intangible medium that is capable of storing, encoding or carrying instructions for execution by the machine, and includes digital or analog communications signals or other intangible media to facilitate communication of such software.

### Non-Limiting Embodiments

While the inventive subject matter has been described with reference to specific embodiments, it will be understood by those skilled in the art that various changes may be made and equivalents may be substituted for the elements thereof without departing from the true spirit and scope of the inventive subject matter. In addition, modifications may be made without departing from the basic teachings of the inventive subject matter. Moreover, each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the inventive subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the inventive subject matter should be determined with reference to the appended claims, along with the full scope of equivalents to which such claims are entitled.

What is claimed is:

1. A method of printing, onto a substrate, layered arrays of spots, which method includes:
printing a first array of spots onto the substrate;
allowing the first array of spots to dry;
printing, over the first array of spots, a second array of spots, the spots of the second array being at least partially coincident with the spots of the first array;
allowing the second array of spots to dry;
printing, over the second array of spots, a third array of spots, the spots of the third array being at least partially coincident with the spots of the second array; and
allowing the third array of spots to dry.

2. The method of claim 1, further comprising including a nucleic acid solution in one of the arrays of spots.

3. The method of claim 1, further comprising including a transfection reagent in one of the arrays of spots.

4. The method of claim 1, further comprising including a gelatin solution in one of the arrays of spots.

5. The method of claim 1, wherein the first array of spots includes a nucleic acid solution, the second array of spots includes a transfection agent, and the third array of spots includes a gelatin and sucrose solution.

6. The method of claim 1, further comprising overlaying cells over at least one of the arrays of spots.

7. The method of claim 1, further comprising overlaying mammalian cells over the third array of spots.

8. The method of claim 6, further comprising placing the cells and at least one array of spots into culture for at least 48 hours.

9. The method of claim 6, further comprising chemically fixing and staining the cells with antibodies or a fluorescent marker, and imaging the cells.

10. The method of claim 6, wherein 150 to 210 cells are overlaid per spot.

11. The method of claim 1, further comprising allowing the first array of spots to dry for 48-72 hours.

12. The method of claim 1, further comprising allowing the second array of spots to dry for 72-96 hours.

13. The method of claim 1, further comprising allowing the third array of spots to dry for 3-5 days.

14. The method of claim 1, further comprising including a fluorescent dye in one of the arrays of spots, and imaging the spots using a fluorescent imaging device.

15. The method of claim 2, wherein the nucleic acid solution includes an RNA and/or a DNA encoded expression vector.

16. The method of claim 15, wherein the RNA in the nucleic acid solution includes an siRNA, a μRNA, or a non-coding RNA.

17. The method of claim 15, wherein the expression vector in the nucleic acid solution includes a cDNA expression, an shRNA expression, or a genomic DNA encoded vector.

18. The method of claim 2, wherein the nucleic acid solution includes a fluorescent dye labeled nucleotide and a control including siRNA directed toward the NFkB subunit p65.

19. The method of claim 3, wherein the transfection reagent includes RNAi max invitrogen.

20. The method of claim 1, further comprising storing one of the printed arrays before overlay printing of another array.

21. The method of claim 1, further comprising printing one of the arrays of spots using 330 μm outer diameter capillary tubes.

22. The method of claim 1, further comprising printing one of the arrays of spots using 400 μm outer diameter capillary tubes.

23. The method of claim 1, wherein at least one printed array of spots includes spots of a different size to spots included in another array of printed spots.

24. The method of claim 4, wherein a concentration of gelatin in the gelatin solution is in a range of 0.4% to 3.2% w/v.

25. The method of claim 1, wherein the first, second and third arrays of spots substantially coincide and form layered transfection arrays on the substrate when dry.

26. The method of claim 1, wherein the layered arrays of spots of reagent compositions are each printed by:
displacing an array of reagent composition containing capillary tubes arranged alongside one another and each having at least one open end, with the open ends of the tubes being aligned, from an inoperative position to an operative position in which the open ends of the capillary tubes simultaneously impinge against a substrate, so that at least some reagent composition from the capillary tubes is thereby deposited on the substrate as spots, thereby to form an array of spots of the reagent compositions on the substrate; and
thereafter displacing the array of capillary tubes from the operative position back to the inoperative position.

27. The method of claim 26, further including, after the array of capillary tubes has been displaced back to its inoperative position, or while it is being so displaced, replacing the substrate bearing the array of spots with another substrate, and repeating the displacement of the array of capillary tubes from its inoperative position to its operative position, and back to its inoperative position.

28. The method of claim 27, further including, before the displacing of the array of capillary tubes from the inoperative position to the operative position, forming the array of capillary tubes by supporting the capillary tubes on or against a plurality of supporting elements, with each supporting element supporting a plurality of the capillary tubes and stacking the supporting elements into a print head assembly, with the displacing of the capillary tubes being effected by moving the print head assembly.

29. A printing apparatus for printing, onto a substrate, an array of spots of reagent composition, which apparatus includes:
an array of capillary tubes arranged alongside one another and each having at least one open end, with the open ends of the tubes being aligned;
displacement means for displacing the array of capillary tubes from an inoperative position to an operative position and back to the inoperative position; and
substrate holding means for holding the substrate so that, in use, when the array of capillary tubes is displaced into its operative position, the open ends of the capillary tubes can simultaneously impinge against a substrate held by the substrate holding means with at least some reagent composition from the capillary tubes being deposited on the substrate as spots, thereby to form an array of spots of the reagent compositions on the substrate.

30. A machine readable medium including instructions that, when implemented, cause the machine to perform operations comprising:
printing a first array of spots onto a substrate;
receiving the first array of spots when dry;
printing, over the first array of dried spots, a second array of spots, the spots of the second array being at least partially coincident with the spots of the first array;
receiving the second array of spots when dry; and
printing, over the second array of dried spots, a third array of spots, the spots of the third array being at least partially coincident with the spots of the second array.

31. A system including at least one module, executing on at least one computer processor, to:
print a first array of spots onto a substrate;
print, over the first array of dried spots, a second array of spots, the spots of the second array being at least partially coincident with the spots of the first array; and
print, over the second array of dried spots, a third array of spots, the spots of the third array being at least partially coincident with the spots of the second array.
